(19) United States
(12) Patent Application Publication
(10) Pub. No.: US 2015/0337101 A1
(43) Pub. Date: Nov. 26, 2015

(54) RIGID POLYSTYRENE FOAMS, A MOLDED BODY AND INSULATION CONTAINING RIGID POLYSTYRENE FOAMS

(71) Applicant: SGL CARBON SE, WIESBADEN (DE)

(72) Inventors: WILHELM FROHS, ALLMANNSHOFEN (DE); WERNER HANDL, ALTDORF (DE)

(21) Appl. No.: 14/818,727

(22) Filed: Aug. 5, 2015

Related U.S. Application Data
(63) Continuation of application No. PCT/EP2014/052274, filed on Feb. 5, 2014.

(30) Foreign Application Priority Data
Feb. 5, 2013 (DE) 102013201844.4

(51) Int. Cl. C08J 9/00

(52) U.S. Cl. CPC C08J 9/0066; C08J 9/0019; C08J 2205/10; C08J 2325/06

(57) ABSTRACT

Rigid polystyrene foams contain thermally treated non-graphitic anthracite coke particles. Such athermanous materials permit a more energy-efficient grinding process, wherein the ground particles are yielded in the desired platelet form and these ground particles also disperse well in a polystyrene matrix. Therefore the rigid polystyrene foams containing the anthracite coke particles have a density of less than 40 kg/m³ and a thermal conductivity of less than 40 mW/m·K which provides desired thermal insulation properties.

### CROSS-REFERENCE TO RELATED APPLICATION

This is a continuation application, under 35 U.S.C. §120, of copending international application No. PCT/EP2014/052274, filed Feb. 5, 2014, which designated the United States; this application also claims the priority, under 35 U.S.C. §119, of German patent application No. DE 10 2013 201 844.4, filed Feb. 5, 2013; the prior applications are herewith incorporated by reference in their entirety.

### BACKGROUND OF THE INVENTION

### Field of the Invention

The present invention relates to rigid polystyrene foams containing thermally treated non-graphitic anthracite coke particles, moldings containing such rigid polystyrene foams and the use of such moldings for heat insulation.

Rigid polystyrene foams have long been known and are used inter alia as heat insulation in the form of panels in the building industry. The rigid polystyrene foam has a closed cell structure, i.e. a few percent of this foam contains rigid polystyrene with the majority containing trapped air. The closed cell structure results in low thermal conductivity which makes the rigid polystyrene foam well suited for use as heat insulation. Here, the density of the rigid polystyrene foam, which is determined by the level of foaming of the polystyrene particles, has a decisive influence on the thermal conductivity. The thermal insulation panels used in the building industry which are made of rigid polystyrene foam have, for example, densities of 20 or 30 kg/m³, which corresponds to a thermal conductivity of 40 to 35 mW/m·K. To ensure that as little polystyrene as possible is used, i.e. to save material, rigid polystyrene foam with a density of less than 20 kg/m³ has also been considered, however, the thermal conductivity of this rigid polystyrene foam is too high at more than 45 mW/m·K. It is known to add athermanous materials to the rigid polystyrene foam to provide rigid polystyrene foam panels with densities of less than 30 kg/m³, preferably of less than 20 kg/m³, which, despite the low density specified, have a lower satisfactory thermal conductivity for use as an insulating material. Athermanous materials are understood to be materials which absorb heat, in particular heat caused by infrared radiation. Accordingly, therefore, the addition of athermanous materials reduces the radiation conductivity for the rigid polystyrene foam. Metal oxides, e.g. Al₂O₃ or Fe₂O₃, non-metal oxides, e.g. SiO₂, metal, aluminum powder, soot, graphite, calcined petroleum coke, meta-anthracite, anthracite or organic coloring agents or color pigments have been suggested as athermanous materials which can be added to the rigid polystyrene foam (see EP 0620246, WO 97/45477, WO 98/51734 (corresponding to U.S. Pat. No. 6,130,265), WO 00/43442 (corresponding to U.S. Pat. No. 6,465,533), WO 2010/031537 (corresponding to U.S. Pat. No. 8,680,170), DE 202010013 850, DE 202010013851). Through the addition of these athermanous materials, a rigid polystyrene foam can be produced which has a density of less than 20 kg/m³ and a thermal conductivity of less than 40 mW/m·K, preferably of less than 35 mW/m·K. However, if finely ground graphite or calcined petroleum coke is used as the athermanous material, an energy-intensive grinding process is required. Furthermore, it is difficult to disperse the, for example, ground graphite particles in the polystyrene matrix. The raw material costs constitute an additional disadvantage, in particular, in the use of anisotropic petroleum cokes, such as needle cokes. DE 202010013850 describes the use of carbon-bearing athermanous materials, such as meta-anthracite or anthracite, which have both graphitic and turbostratic structures and, therefore, belong to the class of graphitic carbons (see IUPAC Nomenclature). The rigid polystyrene foams containing such athermanous particles exhibit an increased intrinsic thermal conduction due to the partially graphitic structure of these particles. This leads to an increased coefficient of thermal conductivity and, therefore, to poorer heat insulation.

### SUMMARY OF THE INVENTION

For this reason, one task of the present invention is to provide an alternative rigid polystyrene foam containing an athermanous material which is suitable for heat insulation and which has a density of less than 40 kg/m³, preferably of less than 20 kg/m³ and a thermal conductivity of less than 40 mW/m·K, preferably of less than 35 mW/m·K. The athermanous material added should permit a more energy-efficient grinding process, wherein the ground particles are yielded in the desired platelet form and these ground particles also disperse well in a polystyrene matrix.

In the context of the present invention, this task is solved by a rigid polystyrene foam which contains thermally treated, non-graphitic anthracite coke particles. In so doing, theses anthracite coke particles act as an athermanous material.

Wherever anthracite coke particles are mentioned subsequently, thermally treated, non-graphitic anthracite coke particles are meant.

According to the invention, it was recognized that rigid polystyrene foams containing anthracite coke particles, preferably gas-calcined anthracite coke particles, have a density of less than 40 kg/m³, preferably of less than 20 kg/m³, and a thermal conductivity of less than 40 mW/m·K, preferably of less than 35 mW/m·K, i.e. it is possible to provide the desired thermal insulation properties. Furthermore, the anthracite coke particles can be ground more energy efficiently when compared to, for example, graphite particles (natural graphite or synthetic graphite) as the corresponding throughput capacity is increased, wherein additionally the proportion of unusable by-product (fine filter dust) is smaller when compared to graphite. Graphitic anthracite, which can be obtained by heat treatment in excess of 2200° C., constitutes a synthetic graphite. Moreover, the ground anthracite coke particles can be obtained in the desired platelet form. Furthermore, the anthracite coke particles disperse better in the polystyrene matrix compared to graphite particles as they are wetted better by the polystyrene matrix due to their surface properties and are, therefore, dispersed better. It has emerged surprisingly that the anthracite coke particles form fewer agglomerates and, therefore, require fewer shearing forces for homogeneous dispersion. This is an advantage, in particular, when incorporating anthracite coke particles into the suspension and/or emulsion polymerization process.

According to the present invention, the rigid polystyrene foam can be extruded rigid polystyrene foam (XPS) or polystyrene particle foam (EPS).

A distinction is made between the rigid foams based on the manufacturing process. XPS is manufactured in extrusion systems as a foam thread; in so doing the polystyrene is melted in the extruder and is continuously discharged through a wide-slot nozzle after the addition of a propellant, such as CO₂, wherein the foam thread builds up behind the wide-slot nozzle. This process allows foams with a thickness of between 20 and 200 mm to be produced. After passing through a cooling zone, the foam thread is sawed using downstream machines to achieve the desired form, i.e. blocks, panels or moldings. This extruded rigid polystyrene foam is a closed-cell foam, only absorbs small amounts of moisture, and is resistant to aging. XPS is marketed, for example, under the name Styrodur® C or Styrofoam®. During the manufacture of EPS, polystyrene granules (polystyrene chips), into which the propellant pentane is polymerized, are pre-expanded at temperatures in excess of 90° C. The temperature causes the propellant to evaporate and inflates the thermoplastic base material by 20 to 50 times to form polystyrene foam particles. Blocks, panels or moldings are then produced from these foam particles in continuously or discontinuously operating plants by a second hot steam treatment at between 110° C. and 120° C. EPS constitutes a predominantly closed cell insulation material with trapped air, wherein EPS contains 98% air and is also moisture resistant. EPS is marketed, for example, under the name Styropor®.

Polystyrene, suitable for the present invention, can be obtained by suspension polymerization of, for example, styrene in the presence of anthracite coke particles. In this process, the styrene is polymerized in an aqueous suspension in the presence of anthracite coke particles, and a propellant, such as pentane, is added before, during or after polymerization. During the emulsion polymerization, for example, styrene is emulsified in water, wherein emulsifiers are used to stabilize the emulsion. The initiators used for the polymerization are water soluble, wherein the polymerization is also carried out in the presence of anthracite coke particles.

Expandable styrene polymerizates, in particular from homo- and copolymers of styrene, preferably crystal-clear polystyrene (GPPS), impact-resistant polystyrene (HIPS), anionically polymerized polystyrene, or impact-resistant polystyrene (A-IPS), styrene-alpha-methylstyrene copolymers, acrylonitrile butadiene styrene polymerizates (ABS), styrene-acrylonitrile (SAN) acrylonitrile styrene acrylic esters (ASA), methacrylate-butadiene-styrene (MBS) and methyl methacrylate acrylonitrile can be used as polymerizates in the processes described above.

Preferably the polystyrene has a weight average M_{w} in the range of 150,000 g/mol to 350,000 g/mol, particularly preferably of 150,000 g/mol to 300,000 g/mol, more particularly preferably of 180,000 g/mol to 250,000 g/mol. The weight average M_{w} can be determined via gel permeation chromatography at room temperature, wherein, for example, tetrahydrofuran can be used as eluent.

In the context of the invention it is preferred that the anthracite coke particles are homogeneously distributed in the rigid polystyrene foam. While on the one hand this homogeneous distribution of the anthracite coke particles in the rigid polystyrene foam, in particular in polystyrene particle foam (EPS), does not impair the fine cell structure of the styrene polymerizate particles, in particular of the expanded styrene polymerizate particles, improved thermal insulation properties of the rigid polymer foam produced ensue on the other hand. Consequently, the anthracite coke particles do not have a disruptive effect on nucleation during the manufacture of, for example, EPS. This homogeneous distribution of the anthracite coke particles is also supported by the good dispersibility of these particles in the polystyrene matrix. The surface properties of these anthracite coke particles allow them to be wetted well by the polystyrene matrix, which ensures better dissipation of the agglomerates during dispersion, i.e. there are fewer agglomerates overall in the polystyrene matrix.

In a further preferred embodiment of the present invention the anthracite coke particles have a platelet form. While on the one hand the platelet form of the anthracite coke particles does not impair the fine cell structure of the styrene polymerizate particles either, particularly of the expanded styrene polymerizate particles, on the other hand the platelets have a larger surface area compared to the spherical shape, whereby these platelets have a highly reflective influence on the incident infrared radiation. In an even more preferred embodiment of the present invention the anthracite coke particles have an aspect ratio greater than 2, preferably greater than 10, particularly preferably greater than 20. Advantageously, these aspect ratios are in a range from 2 to 20, particularly preferably in a range from 10 to 50, and even more particularly preferably in a range from 20 to 100. Aspect ratio is understood to mean the circle diameter (D) of the surface of the platelet to the thickness (T) of the platelet, as shown in FIG. 1.

The incident infrared radiation is particularly well reflected in these aspect ratios. The good reflection of the infrared radiation means that this radiation is only slightly absorbed. This means, for example, that the moldings produced from the rigid polystyrene foam according to the invention are not strongly heated in sunlight and are, therefore, not deformed.

In the context of the invention it is preferred that the anthracite coke particles have a diameter d₅₀ of 0.2 bis 20.0 μm, particularly preferred of 0.5 to 15.0 μm, more particularly preferred of 1.0 to 10.0 μm, most particularly preferred of 2.0 to 6.0. The d₅₀ value specifies the mean particle size, wherein 50% of the particles are smaller than the specified value.

As a general rule, the thermal treatment of anthracite is carried out on an industrial scale in gas-fired shaft kilns or in electrically operated kilns. As a result of this calcination technology, reference is also made to gas-calcined anthracites (GCA) and electrically calcined anthracites (ECA). With gas calcined anthracite, a non-graphitic anthracite coke is obtained due to the temperature range at which the anthracite is treated. With electrocalcination, a non-graphitic anthracite coke is also obtained if treated at a temperature below 2,200° C. If green anthracite is treated at temperatures in excess of 2,200° C., a graphitic carbon, i.e. a synthetic graphite with an anthracite base is obtained.

The thermal treatment of green anthracite in a temperature range from 500° C. to 2,200° C. can lead to the desired non-graphitic anthracite cokes being produced. When thermally treated anthracite is used in accordance with this invention, the thermal treatment is carried out in the form of gas calcination or electrocalcination, preferably in the form of gas calcination. In the gas calcination the anthracite is treated at temperatures within a range of 1,200° C. to 1,500° C., and in electrocalcination at temperatures within a range of 1,800° C. to 2,200° C., wherein there is no formation of graphitic areas. In the context of the invention it is preferred that an anthracite coke, produced using gas calcination, is used. In most cases the starting material is a green anthracite, i.e. a coal with the highest degree of carbonization and a reflective surface. In principle, anthracites are characterized by a low content of volatile matter when compared to other coal types (<10 percent by weight (wt %)), a density of approximately 1.3 to 1.4 g/cm³ and a carbon content of >92 wt %. The energy content ranges from approximately 26 MJ/kg to 33 MJ/kg. The maceral content, i.e. the content of organic rock-forming components, should have the following values:

Colinite content >20%, preferred >50%, telinite content <45%, preferred <20% and vitrinite content >60%, preferred >70%.

Preferably a high-quality anthracite is used for the present invention which, after gas or electrocalcination, has a volatile matter content of less than 5 wt % and a carbon content of at least 95 wt %.

Other features which are considered as characteristic for the invention are set forth in the appended claims.

Although the invention is illustrated and described herein as embodied in rigid polystyrene foams, a molded body and insulation containing rigid polystyrene foams, it is nevertheless, not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration for explaining an aspect ratio of a platelet;

FIG. 2 are X-ray diffractograms of various graphite structures according to the invention;

FIG. 3 is an X-ray diffractogram of thermally treated non-graphite anthracite coke particles; and

FIG. 4 is an X-ray diffractogram showing interference in the thermally treated non-graphite anthracite coke particle.

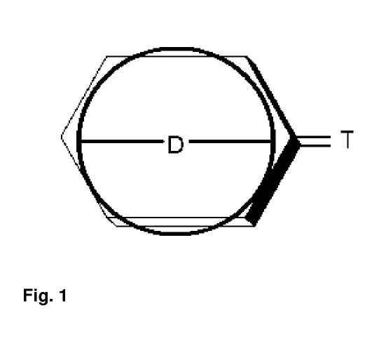

### DETAILED DESCRIPTION OF THE INVENTION

An anthracite, which, for example, has been subjected either to gas calcination at approximately 1,250° C. or to electrocalcination at 1,800° C. to 2,200° C., can be characterized as follows:

| | Gas calcination | Electrocalcination |
|---|---|---|
| Density [g/cm³] | >1.7, preferred >1.8 | >1.7, preferred >1.8 |
| Sulfur [wt %] | <7.0, preferred <5.0 | <1.0, preferred <0.5 |
| Hydrogen content [wt %] | <0.2, preferred <0.15 | <0.08, preferred <0.05 |
| Ash [wt %] | <8.0, preferred <5.0 | <6.0, preferred <5.0 |

The anthracite coke in accordance with the present invention preferably has a density of >1.8 g/cm³, preferably a sulfur content of <5.0 percent by weight (wt %), preferably a hydrogen content of <0.15 wt %, and preferably an ash content of <5.0 wt %.

To ensure the low thermal conductivity of the heat insulation panels, as well as the comparatively energy efficient particle processing, it is essential for the anthracite coke particles to be in a completely non-graphitic state structurally.

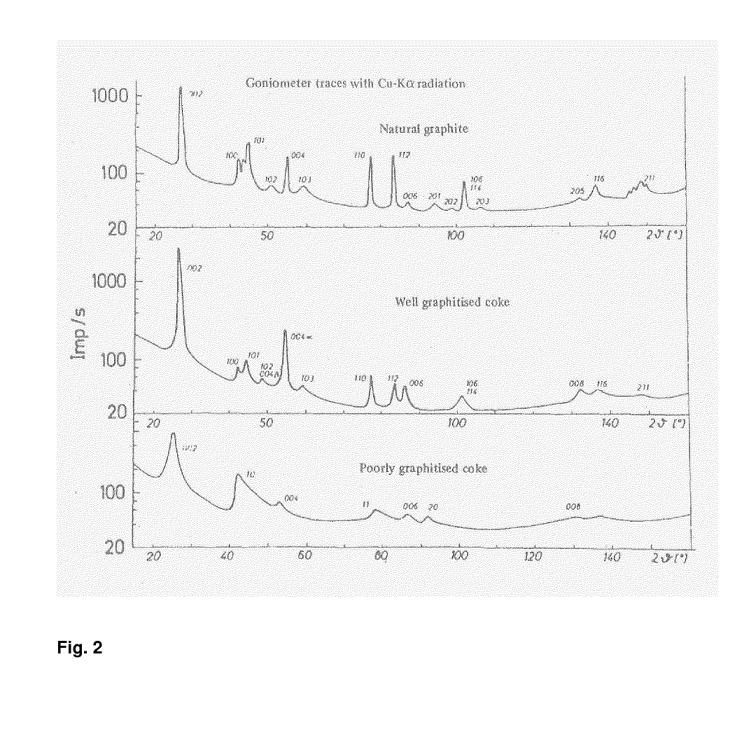

X-ray structural analysis, in the form of powder diffractometry in Bragg-Brentano arrangement and Cu_{α} radiation, is used to prove the non-graphitic structure and its distinction from graphitic structures or partially graphitic structures. A graphitic or partially graphitic structure occurs if the three-dimensional interferences of the graphite lattice (100/101/102/110 and 112) are demonstrable in the X-ray diffractogram, as shown in FIG. 2 (see Fitzer, Funk, Rozploch, 4th London International Carbon and Graphite Conference, 1974).

The International Union of Pure and Applied Chemistry (IUPC) provide the following descriptions for the two expressions “graphitic and non-graphitic carbon (German translation, Deutsche Keramische Gesellschaft, Committee of Experts report No. 33, 3. Report from the “Carbon” working group, Terminology for the Description of Carbon as a Solid, W. Klose, K.-H. Köchling, C. Vogler, R-Wolf, 2009, ISBN 978-3-89958-770-8.

Graphitic Carbon:

Description:

Graphitic carbons are all varieties of substances consisting of the allotropic form of graphite irrespective of the presence of structural defects.

Note:

The use of the term graphitic carbon is justified if a three-dimensional hexagonal crystalline long-range order can be detected in the material by diffraction methods, independent of the volume fraction and the homogeneity of distribution of such crystalline domains. If no three-dimensional long-range order can be detected, the term non-graphitic carbon should be used.

Non-Graphitic Carbon

Description:

Non-graphitic carbons are all varieties of solids consisting mainly of the element carbon with two-dimensional long-range order of the carbon atoms in planar hexagonal networks. Apart from more or less parallel stacking, there is, however, no measurable crystallographic order in the third direction (c-direction).

Note:

Some varieties of non-graphitic carbon convert on heat treatment to graphitic carbon (graphitizable carbon) but some others do not (non-graphitizable carbon).

As the (002) interference is easy to measure due to its high intensity, the average layer spacing obtained from it by means of the Braggs equation is often used for the first distinction between graphitic and non-graphitic carbons (Maire and Mehring (Proc. of the 4th Conf. On Carbon, Pergamon Press 1960, S. 345-350). Therefore, non-graphitic carbons have an average layer spacing of >0.344 nm. A degree of carbonization is often calculated according to Maire and Mehring from the layer spacings between 0.3354 nm and 0.344 nm. Small graphitic volume fractions can be easily identified in a non-graphitic carbon environment due to their increased X-ray intensity as compared to a non-graphitic environment. This can be the case with an amalgamation of non-graphitic and graphitic carbons. Other cases of these occurrences are catalytic carbonization effects during the outbreak of sulfur or the decomposition of metal carbides.

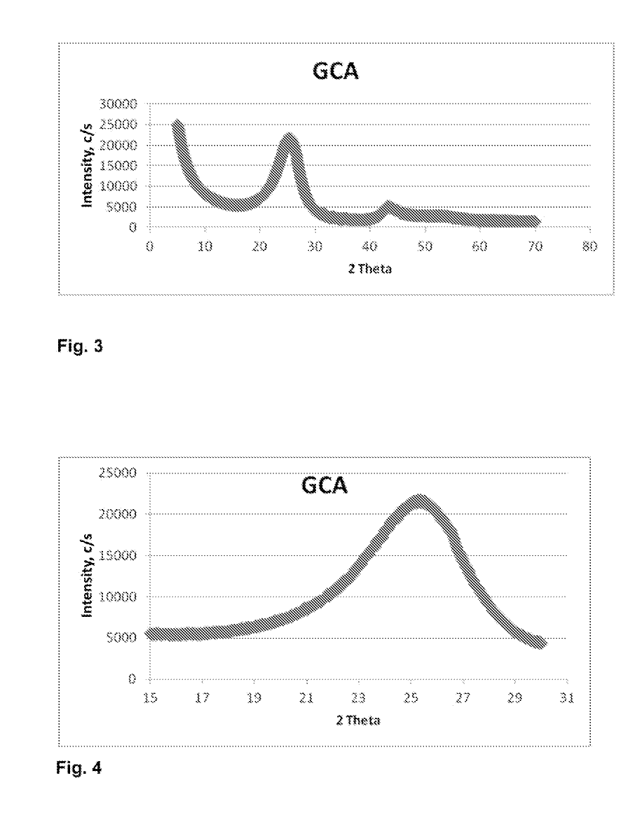

The athermanous particles used in accordance with the invention are thermally treated non-graphitic anthracite coke particles which constitute non-graphitic carbons. An X-ray diffractogram ensues for the thermally treated, non-graphitic anthracite coke particles used in the examples, as shown in FIG. 3.

Table 1:

### X-Ray Data of the Thermally Treated Non-Graphitic Anthracite Coke

| | | Apparent crystallite | Mean layer |
|---|---|---|---|
| | Half width, | size in c-direction, | spacing, |
| (002), 2 Theta | Theta | mean stack height, L_{c}, nm | c/2, nm |
| 25.28 | 4.45 | 180 | 0.3523 |

The X-ray diffractogram according to FIG. 3 shows only a wide (002) interference and the homologous (004) interference. Three-dimensional interferences cannot be identified. The (002) interference in FIG. 4 does not allow even partial identification of any graphitized phase. The average layer spacing from the angle position of the (002) interference is calculated at 0.3523 nm and is, therefore, well above the threshold value for graphitic carbons of <0344 nm (see Table 1).

Heat treatments of graphitic carbons, such as anthracite, above 2,200° C. lead to the formation of graphitic areas. Therefore, the thermal conductivity of these carbons also increases which is not desirable in this case. The following X-ray-graphic data, for example, ensues for electrically calcined anthracite which was subjected to a heat treatment in excess of 2,200° C.:

2 Theta=26.52°, c/2=0.3361 nm, L_{c}=1840 nm. This therefore involves a non-desirable synthetic graphite with an anthracite base.

In an even more preferred embodiment of the present invention, the rigid polystyrene foam contains anthracite coke particles in a quantity of 0.5 wt % to 10.0 wt %, preferably of 1.0 wt % to 8.0 wt %, particularly preferably of 2.0 wt % to 6.0 wt %, more particularly preferably of 2.5 wt % to 4.5 wt % with regard to the quantity of rigid foam.

The use of anthracite coke particles is also advantageous in that the particles are obtained in the desired platelet form after grinding. Jet mills selected from the group containing air, gas and steam jet mills can be used for grinding. Preferably a spiral jet mill or opposed jet mill is used as the air jet mill, particularly preferably a spiral jet mill or opposed jet mill having an integrated air classifier. By using these mills the particles to be ground are accelerated such that the forces exerted on the particles facilitate a direction-dependent crushing, i.e. friction forces and tensile forces, as well as particle collisions occur which lead to a desired crushing of the particles, as well as to a preferred particle form.

If the rigid polystyrene foams are used in the building industry as heat insulation material in the form of panels, it is essential for these insulation materials to be hard to flare up, i.e. for them to pass fire tests B1 and B2 pursuant to DIN 4102. Additionally, the rigid foams can contain flame retardants so that rigid polystyrene foams in accordance with the invention do not flare up easily and pass the required fire tests. These flame retardants constitute organic halogen compounds, preferably organic bromine compounds, particularly preferably aliphatic, cycloaliphatic or aromatic bromine compounds and/or phosphorous compounds. Particularly preferred are the organic bromine compounds from the group containing hexabromcyclododecane, pentabrommonochlorcyclohexane and pentabromphenyl allyl ether and 9,10-Dihydro-9-oxa-10-phosphaphenantrene 10-oxide (DOP-O) or triphenyl phosphate (TPP) are particularly preferred for use as phosphorous compounds. In the rigid polystyrene foams in accordance with the invention, the required amount of flame retardant can be reduced, i.e. the flame retardants in the rigid polystyrene foam are in a quantity of less than 2.0 wt %, preferably of less than 1.5 wt %, particularly preferably of less than 1.0 wt %, with regard to the quantity of rigid foam. Therefore, the rigid polystyrene foam in accordance with the invention can be produced more cheaply and in a more environmentally friendly way as less flame retardant, in particular fewer organic bromine compounds and/or phosphorous compounds, is required.

A more cost-efficient production of the rigid polystyrene foam in accordance with the invention is also possible in that the rigid foam has a density of 1 to 20 kg/m³, preferably of 5 to 20 kg/m³, particularly preferably of 10 to 20 kg/m³, and more particularly preferably of 12 to 18 kg/m³. This results in a saving of material as less polystyrene can be used.

The rigid polystyrene foam in accordance with the invention has a thermal conductivity of 20 mW/m·K to 40 mW/m·K, preferably of 25 mW/m·K to 35 mW/m·K.

The present invention also relates to a molding which contains rigid polystyrene foam in accordance with the invention, and the use of such a molding for heat insulation. Panels which are used for heat insulation, preferably in the building industry, can be considered as moldings.

The invention is explained below using examples, wherein these examples do not constitute a limitation of the invention.

In comparison to these examples, rigid polystyrene foams, which as athermanous particles contain anthracite particles having graphitic structures, demonstrate thermal conductivity values which are worse by up to 2 W/m·K.

### EXAMPLES

### Example 1

Polystyrene with a molecular weight of 220,000 g/mol was melted in an extruder together with 3.5 wt % gas-calcined anthracite coke particles produced in a jet mill with an average particle diameter d₅₀ of 3.5 μm and an aspect ratio of 20, as well as with 0.8 wt % hexabromcyclododecane and 0.1 wt % dicumyl. 6.5 wt % pentane was then added before cooling to approximately 120° C. The mixture obtained in this way was delivered through a hole-type nozzle as endless threads, cooled over a cooling bath and granulated to form individual pieces using a string granulator. The cylindrical granulates were approximately 0.8 mm in diameter and approximately 10.0 mm in length. The granulate was then foamed to a density of 15 kg/m³. After being conditioned for 24 hours, blocks were pressed out of it and cut to 50 mm thick panels using hot wire. The panels produced in this way had an average coefficient of thermal conductivity of 32 mW/m·K.

### Example 2

With regard to the styrene components, 4 wt % of gas-calcined anthracite coke particles produced in a spiral jet mill and with an average particle diameter of 3.0 μm and an aspect ratio of 45 were admixed in an aqueous suspension polymerization process according to known prior art, and peroxidically polymerized together with 1.5 wt % hexabromcyclododecane as flame retardant, as well as pentane as foaming agent. The beads obtained after separating off the aqueous phase had an average diameter of 0.8 mm. A coefficient of thermal conductivity of 33 mW/m·K was determined after foaming the beads with water vapor to form panels with a density of 14.5 kg/m³.

### Example 3

In a continuously operating extruder, polystyrene with a molecular weight of 220.000 g/mol is melted together with 1.0 wt % hexabromcyclododecane and 0.2 wt % dicumyl, as well as 3.5 wt % gas-calcined anthracite coke particles produced in an opposed jet mill and with an average particle diameter of 4.0 μm and an aspect ratio of 35. The foaming was carried out directly in the extruder to achieve the final density. The polystyrene foam was discharged endlessly through a wide-slot nozzle and cooled. The moldings had a density of 14 kg/m³ and a coefficient of thermal conductivity of 31 mW/m·K.

1. A rigid polystyrene foam, comprising:
thermally pretreated non-graphitic anthracite coke particles.

2. The rigid polystyrene foam according to claim 1, wherein the rigid polystyrene foam is an extruded rigid polystyrene foam (XPS) or a polystyrene particle foam (EPS).

3. The rigid polystyrene foam according to claim 1, wherein said thermally pretreated non-graphitic anthracite coke particles are distributed homogeneously in the rigid polystyrene foam.

4. The rigid polystyrene foam according to claim 3, wherein said thermally pretreated non-graphitic anthracite coke particles have a platelet form.

5. The rigid polystyrene foam according to claim 4, wherein said thermally pretreated non-graphitic anthracite coke particles have an aspect ratio greater than 2.

6. The rigid polystyrene foam according to claim 5, wherein said thermally pretreated non-graphitic anthracite coke particles have a diameter d₅₀ of 0.2 to 20 μm.

7. The rigid polystyrene foam according to claim 6, wherein said thermally pretreated non-graphitic anthracite coke particles have anthracite coke present as either gas-calcined anthracite or electrocalcinated anthracite.

8. The rigid polystyrene foam according to claim 7, wherein said thermally pretreated non-graphitic anthracite coke particles are contained in a quantity of 0.5 wt % to 10 wt % with regard to a quantity of the rigid polystyrene foam.

9. The rigid polystyrene foam according to claim 8, wherein said thermally pretreated non-graphitic anthracite coke particles are ground in jet mills selected from the group consisting of air mills, gas mills and steam jet mills.

10. The rigid polystyrene foam according to claim 9, wherein the air jet mill constitutes a spiral jet mill or an opposed jet mill.

11. The rigid polystyrene foam according to claim 10, further comprising flame retardants.

12. The rigid polystyrene foam according to claim 11, wherein said flame retardants constitute at least one of organic halogen compounds or phosphorus compounds.

13. The rigid polystyrene foam according to claim 12, wherein the rigid polystyrene foam has a density of 1 to 20 kg/m³ and a thermal conductivity of 20 mW/m·K to 40 mW/m·K.

14. A molded body, comprising:
a rigid polystyrene foam containing thermally pretreated non-graphitic anthracite coke particles.

15. An insulation, comprising:
a rigid polystyrene foam containing thermally pretreated non-graphitic anthracite coke particles.
